(19) United States
(12) Patent Application Publication
(10) Pub. No.: US 2021/0389429 A1
(43) Pub. Date: Dec. 16, 2021

(54) LIDAR SYSTEM

(71) Applicant: Continental Automotive Systems, Inc., Auburn Hills, MI (US)

(72) Inventor: Elliot John Smith, Ventura, CA (US)

(73) Assignee: Continental Automotive Systems, Inc., Auburn Hills, MI (US)

(21) Appl. No.: 16/901,167

(22) Filed: Jun. 15, 2020

(51) Int. Cl. G01S 7/481; G01S 17/894; G01S 17/931; G01S 17/10; B60R 11/00

(52) U.S. Cl. CPC G01S 7/4816; G01S 7/4814; B60R 11/00; G01S 17/931; G01S 17/10; G01S 17/894

(57) ABSTRACT

A Lidar system includes a focal-plane array having a plurality of pixels. Each pixel includes a first single-photon avalanche diode (SPAD) and a second SPAD. The Lidar system operates by, for each of a plurality of the pixels, applying a bias voltage to the first SPAD of the pixel while no bias voltage or low bias voltage is applied to the second SPAD of the pixel, then removing the bias voltage from the first SPAD of the pixel and applying a bias voltage to the second SPAD of the pixel while no bias voltage or low bias voltage is applied to the first SPAD of the pixel, and then recording detection of a photon by the first SPAD of the pixel and detection of a photon by the second SPAD on a common memory bank of the pixel.

### BACKGROUND

A Lidar system includes a photodetector, or an array of photodetectors. Light is emitted into a field of view of the photodetector. The photodetector detects light that is reflected by an object in the field of view. For example, a flash Lidar system emits pulses of light, e.g., laser light, into essentially the entire the field of view. The detection of reflected light is used to generate a 3D environmental map of the surrounding environment. The time of flight of the reflected photon detected by the photodetector is used to determine the distance of the object that reflected the light.

The Lidar system may be mounted on a vehicle to detect objects in the environment surrounding the vehicle and to detect distances of those objects for environmental mapping. The output of the Lidar system may be used, for example, to autonomously or semi-autonomously control operation of the vehicle, e.g., propulsion, braking, steering, etc. Specifically, the system may be a component of or in communication with an advanced driver-assistance system (ADAS) of the vehicle.

The photodetector may be a single-photon avalanche diode (SPAD). The SPAD is a semiconductor device having a p-n junction that is reverse biased (herein referred to as “bias) at a voltage that exceeds the breakdown voltage of the p-n junction. The bias voltage is at a magnitude such that a single photon injected into the depletion layer triggers a self-sustaining avalanche, which produces a readily-detectable avalanche current. The leading edge of the avalanche current indicates the arrival time of the detected photon.

After the initiation of the avalanche, the SPAD does not detect additional photons and thus must be reset by quenching the avalanche current. Specifically, the SPAD is connected to a quenching circuit that senses the leading edge of the avalanche current and quenches the avalanche current by lowering the bias voltage to the breakdown voltage to reset the SPAD to the operative level.

The quenching can be a passive quench or an active quench. During quenching, the SPAD does not detect a returned photon and thus experiences dead time. This dead time can be many nanoseconds for passive quenching and can be 5-10 ns for active quenching. 5 ns of dead time equates to approximately 1.5 m of detection (based on the speed of light to and from an object.

### BRIEF DESCRIPTION OF THE DRAWINGS

FIG. 1 is a perspective view of a vehicle having a Lidar system.

FIG. 2 is a perspective view of the Lidar system.

FIG. 3 is a cross-sectional view of one example of the Lidar system.

FIG. 4 is a cross-sectional view of another example of the Lidar system.

FIG. 5 is a block diagram of components of Lidar system.

FIG. 6 is a schematic view of one example of a focal-plane array of a light-receiving unit of the Lidar system.

FIG. 6A is a magnified view of one pixel of the focal-plane array of FIG. 6.

FIG. 7 is a graph illustrating an example of operation of the Lidar system including the focal-plane array of FIG. 6.

FIG. 8 is a schematic view of another example of a focal-plane array of a light-receiving unit of the Lidar system.

FIG. 8A is a magnified view of one pixel of the focal-plane array of FIG. 8.

FIG. 9 is a flow chart performed for each pixel of the focal-plane array.

### DETAILED DESCRIPTION

With reference to the Figures, wherein like numerals indicate like parts throughout the several views, a Lidar system 10 includes a focal-plane array 12 having a plurality of pixels 14. Each pixel 14 includes a first single-photon avalanche diode (SPAD) and a second SPAD 18. The Lidar system 10 operates by, for each of a plurality of the pixels 14, applying a bias voltage to the first SPAD 16 of the pixel 14 while no bias voltage or low bias voltage is applied to the second SPAD 18 of the pixel 14, then removing the bias voltage from the first SPAD 16 of the pixel 14 and applying a bias voltage to the second SPAD 18 of the pixel 14 while no bias voltage or low bias voltage is applied to the first SPAD 16 of the pixel 14, and then recording detection of a photon by the first SPAD 16 of the pixel 14 and detection of a photon by the second SPAD 18 on a common memory bank 34 of the pixel 14.

Since each pixel 14 includes at least two SPADs, i.e., the first SPAD 16 and the second SPAD 18, and the bias voltage is applied at different times to the first SPAD 16 and the second SPAD 18 of the pixel 14, one of the SPADs may be operable (i.e., biased) to detect a returned photon while the other SPAD is inoperable (i.e., not biased or biased at a low voltage, i.e., below Geiger mode) to detect a returned photon. Accordingly, in an example in which the first SPAD 16 is operable and detects a returned photon, the second SPAD 18 is available to be operated while the first SPAD 16 is quenched in deadtime to the avalanche and subsequent quench of the first SPAD 16 (hereinafter referred to as “quench”). Specifically, the second SPAD 18 is biased so that the second SPAD 18 is operable to detect a returned photon during the dead time of the first SPAD 16 while the first SPAD 16 is quenched. Likewise, after the first SPAD 16 is quenched, the first SPAD 16 is available to be operated when the second SPAD 18 is quenched after detection of a returned photon by the second SPAD 18. This reduces or eliminates the dead time of the pixel 14. The separate operation of the SPADS of the pixel 14 at different times also reduces the chance of a neighboring SPAD causing a false signal since the neighboring SPAD is off or essentially off. As described further below, the pixel 14 may include more than two SPADs with each of the SPADs being alternately biased and/or groups of the SPADs of the pixel 14 being alternately biased.

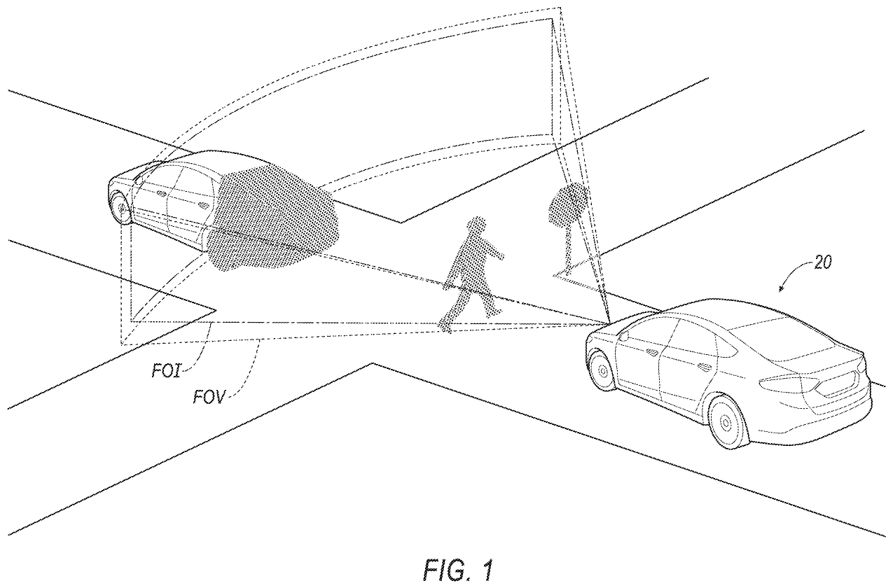

FIG. 1 shows an example vehicle 20. The Lidar system 10 is mounted to the vehicle 20. In such an example, the Lidar system 10 is operated to detect objects in the environment surrounding the vehicle 20 and to detect distances of those objects for environmental mapping. The output of the Lidar system 10 may be used, for example, to autonomously or semi-autonomously control the operation of the vehicle 20, e.g., propulsion, braking, steering, etc. Specifically, the Lidar system 10 may be a component of or in communication with an advanced driver-assistance system (ADAS) of the vehicle 20. The Lidar system 10 may be mounted on the vehicle 20 in any suitable position and aimed in any suitable direction. As one example, the Lidar system 10 is shown on the front of the vehicle 20 and directed forward. The vehicle 20 may have more than one Lidar system 10 and/or the vehicle 20 may include other object detection systems, including other Lidar systems. The vehicle 20 is shown in FIG. 1 as including a single Lidar system 10 aimed in a forward direction merely as an example. The vehicle 20 shown in the Figures is a passenger automobile. As other examples, the vehicle 20 may be of any suitable manned or un-manned type including a plane, satellite, drone, watercraft, etc.

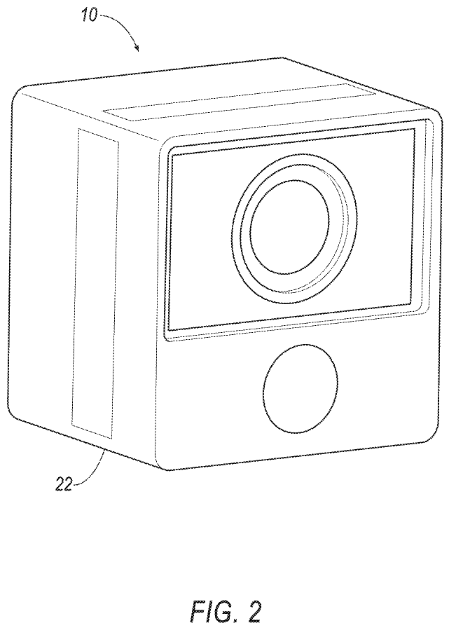

The Lidar system 10 may be a solid-state Lidar system. In such an example, the Lidar system 10 is stationary relative to the vehicle 20. For example, the Lidar system 10 may include a casing 22 (shown in FIG. 2 and described below) that is fixed relative to the vehicle 20, i.e., does not move relative to the component of the vehicle 20 to which the casing 22 is attached, and a silicon substrate of the Lidar system 10 is supported by the casing 22.

As a solid-state Lidar system, the Lidar system 10 may be a flash Lidar system. In such an example, the Lidar system 10 emits pulses of light into the field of illumination FOI. More specifically, the Lidar system 10 may be a 3D flash Lidar system that generates a 3D environmental map of the surrounding environment, as shown in part in FIG. 1. An example of a compilation of the data into a 3D environmental map is shown in the FOV and the field of illumination (FOI) in FIG. 1. A 3D environmental map may include location coordinates of points within the FOV with respect to a coordinate system, e.g., a Cartesian coordinate system with an origin at a predetermined location such as a GPS (Global Positioning System) reference location, or a reference point within the vehicle 20, e.g., a point where a longitudinal axis and a lateral axis of the vehicle 20 intersect.

The Lidar system 10 includes a light-emitting system 24, a light-receiving system 26, and a computer 28 that controls the light-emitting system 24 and the light-receiving system 26. The FPA 12 is a component of the light-receiving system 26 of the Lidar system 10 as discussed below.

In such an example, the Lidar system 10 is a unit. Specifically, the Lidar system 10 may include the casing 22 that supports the light-emitting system 24 and the light-receiving system 26. The casing 22, for example, may be plastic or metal and may protect the other components of the Lidar system 10 from environmental precipitation, dust, etc. In the alternative to the Lidar system 10 being a unit, components of the Lidar system 10, e.g., the light-emitting system 24 and the light-receiving system 26, may be separate and disposed at different locations of the vehicle 20. The Lidar system 10 may include mechanical attachment features to attach the casing 22 to the vehicle 20 and may include electronic connections to connect to and communicate with electronic system of the vehicle 20, e.g., components of the ADAS.

The Lidar system 10 includes outer optical fascia (not numbered), which may be referred to as a “window,” that allows light to pass through, e.g., light generated by the light-emitting system 24 exits the Lidar system 10 and/or light from environment enters the Lidar system 10. The outer optical fascia protects an interior of the Lidar system 10 from environmental conditions such as dust, dirt, water, etc. The outer optical fascia is typically formed of a transparent or semi-transparent material, e.g., glass, plastic, with respect to the wavelength of the emitted light. The outer optical fascia may be opaque at other wavelengths, which may assist in the overall reduction of ambient light. The outer optical fascia may extend from the casing and/or may be attached to the casing.

The Lidar system 10 includes the light emitter 30 that emits shots, i.e., pulses, of light into the field of illumination FOI for detection by a light-receiving system 26 when the light is reflected by an object in the field of view FOV to return photons to the light-receiving system 26. The light-receiving system 26 has a field of view (hereinafter “FOV”) that overlaps the field of illumination FOI and receives light reflected by surfaces of objects, buildings, road, etc., in the FOV. The light emitter 30 may be in electrical communication with the computer 28, e.g., to provide the shots in response to commands from the computer 28.

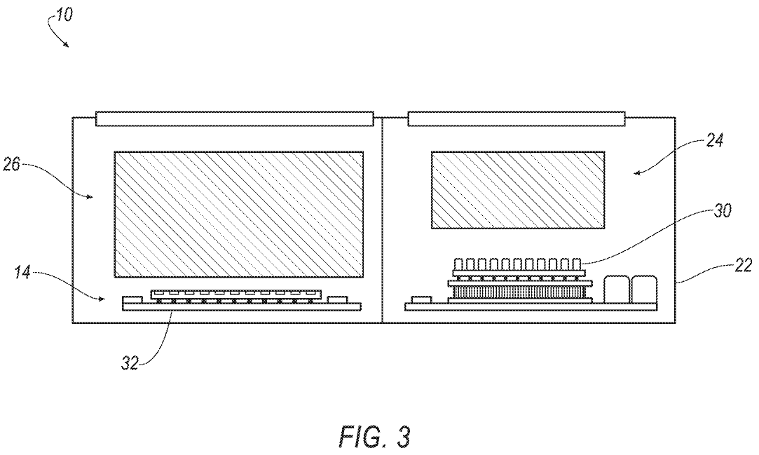

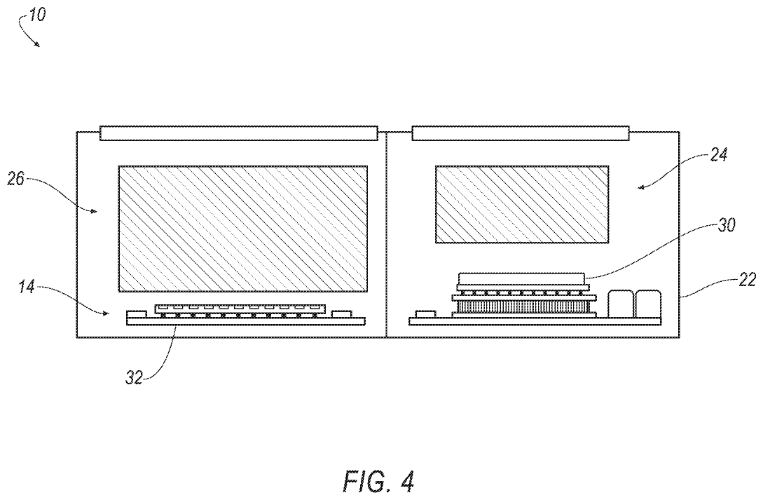

The light-emitting system 24 may include one or more light emitter 30 and optical components such as a lens package, lens crystal, pump delivery optics, etc. The optical components, e.g., lens package, lens crystal, etc., may be between the light emitter 30 on a back end of the casing and the outer optical fascia on a front end of the casing. Thus, light emitted from the light emitter 30 passes through the optical components before exiting the casing through the outer optical fascia. Examples of the light emitting system are shown in FIGS. 3 and 4.

The light emitter 30 may be a semiconductor light emitter, e.g., laser diodes. In one example, as shown in FIG. 3, the light emitter 30 may include a vertical-cavity surface-emitting laser (VCSEL) emitter. As another example shown in FIG. 4, the light emitter 30 may include an edge emitting laser emitter. As another example (not shown), the light emitter 30 may include a diode-pumped solid-state laser (DPSSL) emitter. The light-emitting system 24 is designed to emit a pulsed flash of light, e.g., a pulsed laser light. Specifically, the light emitter 30 is designed to emit a pulsed flash of laser light. The light emitted by the light emitter 30 may be infrared light. Alternatively, the light emitted by the light emitter 30 may be of any suitable wavelength. The Lidar system 10 may include any suitable number of light emitters 30. In examples that include more than one light emitter 30, the light emitters 30 may be identical or different.

With reference to FIGS. 3 and 4, the light-emitting system 24 includes a transmitter driver board (not numbered) including electrical components for actuating the light emitter 30. The driver board provides actuation for the light emitter 30 to emit light. The light-emitting system 24 may include passive components such as capacitors, resistors, etc. The light-emitting system 24 may include a thermal control system. The thermal control system may include one or more cooling devices such as thermal electric coolers (TEC) for cooling the light emitter 30. For example, the Lidar system 10 may include a heat sink on the casing 30 adjacent the light emitter 30. The heat sink may include, for example, a wall adjacent the light emitter 30 and fins extending away from the wall exterior to the casing 30 for dissipating heat away from the light emitter 30. The wall and/or fins, for example, may be material with relatively high heat conductivity. The light emitter 30 may, for example, abut the wall to encourage heat transfer. In addition or in the alternative to the fins, the system may include additional cooling devices, e.g. thermal electric coolers (TEC).

With continued reference to FIGS. 3 and 4, the lens package may include a monolithic optical lens (e.g., glass or plastic) having a light-shaping region. In such examples, the monolithic lens may be of any suitable type that shapes light from the light emitter 30 toward the outer optical fascia. For example, the lens package may include a diffractive optical element, a diffractive diffuser, a refractive diffuser, a blazed grating, etc. The light-receiving system 26 may include receiving optics such as the lens package.

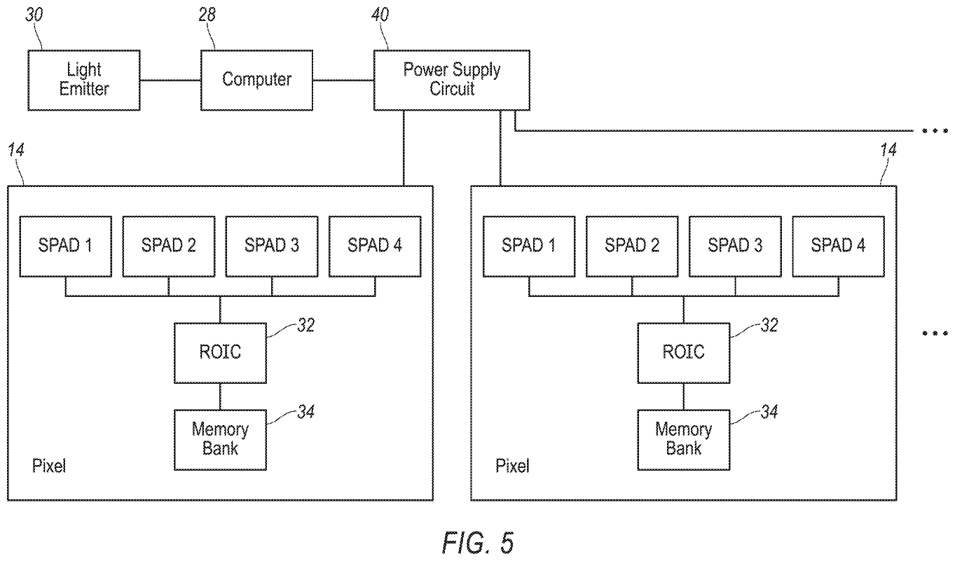

With reference to FIG. 5, the light-receiving system 26 detects light, e.g., emitted by the light emitter 30 and returned to the light-receiving system 26. The light-receiving system 26 may include a focal-plane array (FPA 12). The FPA 12 includes the plurality of pixels 14 and a power-supply circuit 40 that powers the pixels 14. As set forth above, each pixel 14 includes a plurality of SPADs, a read-out circuit (ROIC) in communication with the SPADs, and a memory bank 34. In other words, the FPA 12 includes a plurality of ROICs 32 and memory banks 34 with each ROIC 32 dedicated to one pixel 14 and with each memory bank 34 dedicated to one pixel 14. The memory bank 34 may be in the ROIC 32 of the pixel 14 or may be separate from the ROIC 32. Data from the memory banks 34 will be streamed to a computer.

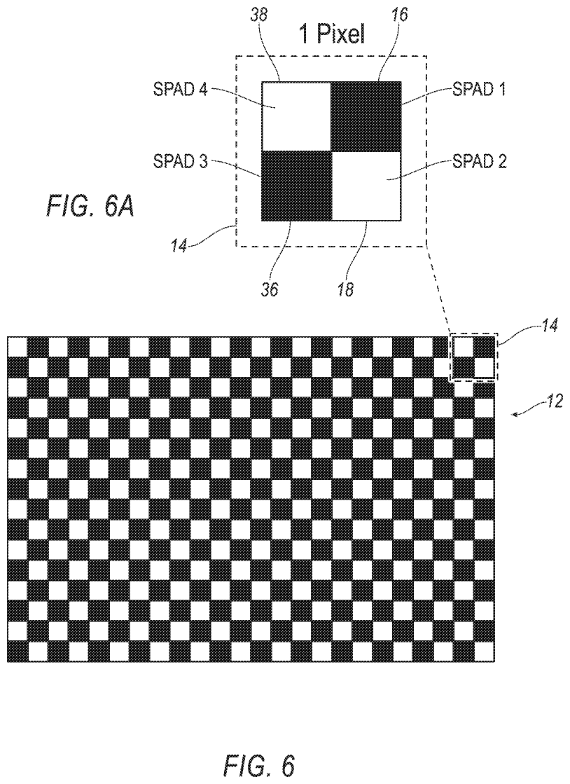

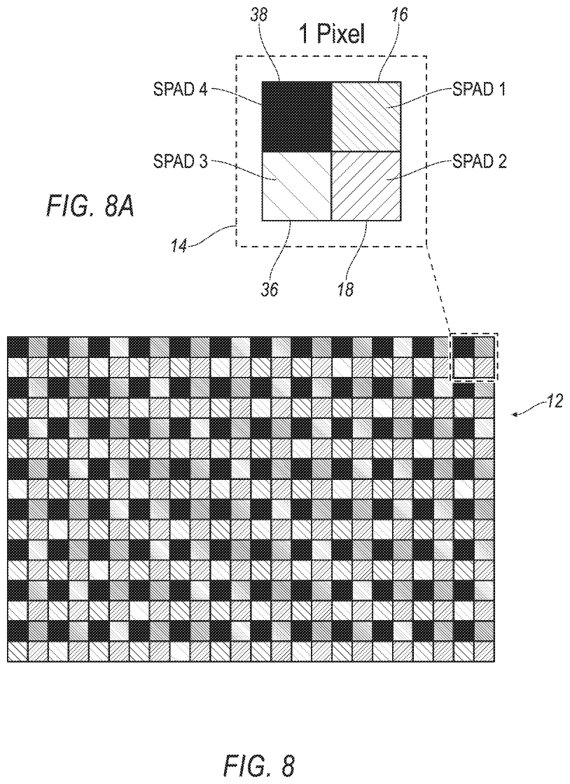

Each pixel 14 may include any suitable number of SPADs, i.e., two or more. As one example, each pixel 14 may include two SPADs, i.e., the first SPAD 16 and the second SPAD 18. In the examples shown in FIGS. 6 and 8, each pixel 14 includes four SPADs, i.e., the first SPAD 16, the second SPAD 18, a third SPAD 36, and a fourth SPAD 38.

The pixels 14 may be arranged as an array, e.g., a 2-dimensional (2D) or a 1-dimensional (1D) arrangement of components. A 2D array of pixels 14 includes a plurality of pixels 14 arranged in columns and rows.

The FPA 12 detects photons by photo-excitation of electric carriers, e.g., with the SPADs. An output from the FPA 12 indicates a detection of light. The outputs of FPA 12 are collected to generate a 3D environmental map, e.g., 3D location coordinates of objects and surfaces within FOV of the Lidar system 10. The FPA 12 may include the SPADs, e.g., that include semiconductor components for detecting light reflections from the FOV of the Lidar system 10. Optical elements such as a lens package of the light-receiving system 26 may be positioned between the FPA 12 in the back end of the casing and the outer optical fascia on the front end of the casing.

The ROIC 32 converts an electrical signal received from the SPADs of the pixel 14 to digital signals. The ROIC 32 may include electrical components which can convert electrical voltage to digital data. The ROIC 32 may be connected to the computer 28, which receives the data from the ROIC 32 and may generate 3D environmental map based on the data received from the ROIC 32.

The pixel 14 functions to output a single signal or stream of signals corresponding to a count of photons incident on the pixel 14 within one or more sampling periods. Each sampling period may be picoseconds, nanoseconds, microseconds, or milliseconds in duration. The pixel 14 can output a count of incident photons, a time between incident photons, a time of incident photons (e.g., relative to an illumination output time), or other relevant data, and the Lidar system 10 can transform these data into distances from the system to external surfaces in the fields of view of these pixels 14. By merging these distances with the position of pixels 14 at which these data originated and relative positions of these pixels 14 at a time that these data were collected, the computer 28 (or other device accessing these data) can reconstruct a three-dimensional 3D (virtual or mathematical) model of a space within FOV, such as in the form of 3D image represented by a rectangular matrix of range values, wherein each range value in the matrix corresponds to a polar coordinate in 3D space.

As set forth above, the FPA 12 includes a power-supply circuit 40 that powers the pixels 14, i.e., to the SPADs. The FPA 12 may include a single power-supply circuit 40 in communication with all pixels 14 or may include a plurality of power-supply circuits 40 in communication with a group of the pixels 14.

The power-supply circuit 40 may include active electrical components such as MOSFET (Metal-Oxide-Semiconductor Field-Effect Transistor), BiCMOS (Bipolar CMOS), IGBT (Insulated-gate bipolar transistor), VMOS (vertical MOSFET), HexFET, DMOS (double-diffused MOSFET) LDMOS (lateral DMOS), BJT (Bipolar junction transistor), etc., and passive components such as resistors, capacitors, etc. The power-supply circuit 40 may include a power-supply control circuit. The power-supply control circuit may include electrical components such as a transistor, logical components, etc. The power-supply control circuit may control the power-supply circuit 40, e.g., in response to a command from the computer 28, to apply bias voltage and quench and reset the SPAD.

As set forth above, each pixel 14 includes a memory bank 34. Specifically, the computer 28 of the Lidar system 10 includes a processor and memory storing instructions executable by the processor. The memory of the Lidar system 10 includes a plurality of memory banks 34. Each memory bank 34 is dedicated to one of the pixels 14. Data output from the ROIC 32 may be stored in the memory bank 34 of the pixel 14, e.g., for processing by the computer 28. The memory of the Lidar system 10 may be DRAM (Dynamic Random Access Memory), SRAM (Static Random Access Memory), and/or MRAM (Magneto-resistive Random Access Memory) electrically connected to the ROIC 32.

Each SPAD (e.g., SPADs 16, 18, 36, 38) is a semiconductor device having a p-n junction that is reverse biased (herein referred to as “bias) at a voltage that exceeds the breakdown voltage of the p-n junction, i.e., in Geiger mode. The bias voltage is at a magnitude such that a single photon injected into the depletion layer triggers a self-sustaining avalanche, which produces a readily-detectable avalanche current. The leading edge of the avalanche current indicates he arrival time of the detected photon. In other words, the SPAD is a triggering device of which usually the leading edge determines the trigger.

“Geiger mode” means that the SPAD is operated above the breakdown voltage of the semiconductor and a single electron-hole pair (generated by absorption of one photon) can trigger a strong avalanche. The SPAD may be biased above its zero-frequency breakdown voltage to produce an average internal gain on the order of one million. Under such conditions, a readily-detectable avalanche current can be produced in response to a single input photon, thereby allowing the SPAD to be utilized to detect individual photons. “Avalanche breakdown” is a phenomenon that can occur in both insulating and semiconducting materials. It is a form of electric current multiplication that can allow very large currents within materials which are otherwise good insulators. It is a type of electron avalanche. In the present context, “gain” is a measure of an ability of a two-port circuit, e.g., the SPAD, to increase power or amplitude of a signal from the input to the output port. As used herein, application of bias voltage to the SPAD results in Geiger mode operation. As also used herein, application of “low bias voltage” to the SPAD is the application of bias voltage that does not result in Geiger mode operation. Specifically, during application of low bias voltage, avalanche breakdown does not occur in response to a single input photon. The SPAD may be supplied bias voltage so that a single photon triggers an avalanche and the SPAD may be supplied no bias voltage or low bias voltage so that avalanche is not triggered by a single input photon.

When the SPAD is triggered in a Geiger-mode in response to a single input photon, the avalanche current continues as long as the bias voltage remains above the breakdown voltage of the SPAD. Thus, in order to detect the next photon, the avalanche current must be “quenched” and the SPAD must be reset. Quenching the avalanche current and resetting the SPAD involves a two-step process: (i) the bias voltage is reduced below the SPAD breakdown voltage to quench the avalanche current as rapidly as possible, and (ii) the SPAD bias is then raised by the power-supply circuit 40 to a voltage above the SPAD breakdown voltage so that the next photon can be detected.

Quenching is performed using, e.g., a quenching circuit or the like, e.g., using known techniques. Each SPAD includes a quenching circuit. Quenching is performed by sensing a leading edge of the avalanche current, generating a standard output pulse synchronous with the avalanche build-up, quenching the avalanche by lowering the bias down to the breakdown voltage and resetting the SPAD to the operative level.

Quenching may be passive or active quenching. A passive quenching circuit typically includes a single resistor in series with the SPAD. The avalanche current self-quenches because it develops a voltage drop across a resistor, e.g., 100 kΩ (Kilo Ohm) or more. After the quenching of the avalanche current, the SPAD bias voltage recovers and therefore will be ready to detect the next photon. An active circuit element can be used for resetting while performing a passive quench active reset (PQAR).

In an active quenching, upon measuring an onset of the avalanche current across a resistor, e.g., 50Ω, a digital output pulse, synchronous with the photon arrival time is generated. The quenching circuit then quickly reduces the bias voltage to below breakdown voltage, then returns bias voltage to above the breakdown voltage ready to sense the next photon. This mode is called active quench active reset (AQAR), however, depending on circuit requirements, active quenching passive reset (AQPR) may be provided. AQAR circuit typically allows lower dead times (times in which a photon cannot be detected) and reduces dead time compare to circuits having passive quenching and/or passive resetting.

The computer 28 of the Lidar system 10 is a microprocessor-based controller implemented via circuits, chips, or other electronic components. The computer 28 is in electronic communication with the pixels 14 (e.g., with the ROIC 32 and power-supply circuits 40) and the vehicle 20 (e.g., with the ADAS) to receive data and transmit commands. The computer 28 includes a processor and a memory. The computer 28 of the vehicle 20 may be programmed to execute operations disclosed herein, including method 900 described below. Specifically, the memory stores instructions executable by the processor to execute the operations disclosed herein and electronically stores data and/or databases, electronically storing data and/or databases. The memory includes one or more forms of computer-readable media, and stores instructions executable by the computer 28 for performing various operations, including as disclosed herein. For example, the computer 28 may include a dedicated electronic circuit including an ASIC (Application Specific Integrated Circuit) that is manufactured for a particular operation, e.g., calculating a histogram of data received from the Lidar system 10 and/or generating a 3D environmental map for a Field of View (FOV) of the vehicle 20. In another example, the computer 28 may include an FPGA (Field Programmable Gate Array) which is an integrated circuit manufactured to be configurable by a customer. As an example, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, and logical components inside an FPGA may be configured based on VHDL programming, e.g. stored in a memory electrically connected to the FPGA circuit. In some examples, a combination of processor(s), ASIC(s), and/or FPGA circuits may be included inside a chip packaging. The computer 28 may be a set of computers communicating with one another via the communication network of the vehicle 20, e.g., a computer 28 in the Lidar system 10 and a second computer 28 in another location in the vehicle 20.

The computer 28 may operate the vehicle 20 in an autonomous, a semi-autonomous mode, or a non-autonomous (or manual) mode. For purposes of this disclosure, an autonomous mode is defined as one in which each of vehicle propulsion, braking, and steering are controlled by the computer 28; in a semi-autonomous mode the computer 28 controls one or two of vehicle propulsion, braking, and steering; in a non-autonomous mode a human operator controls each of vehicle 20 propulsion, braking, and steering.

The computer 28 may include programming to operate one or more of vehicle brakes, propulsion (e.g., control of acceleration in the vehicle 20 by controlling one or more of an internal combustion engine, electric motor, hybrid engine, etc.), steering, climate control, interior and/or exterior lights, etc., as well as to determine whether and when the computer 28, as opposed to a human operator, is to control such operations. Additionally, the computer 28 may be programmed to determine whether and when a human operator is to control such operations.

The computer 28 may include or be communicatively coupled to, e.g., via a vehicle 20 communication bus, more than one processor, e.g., controllers or the like included in the vehicle 20 for monitoring and/or controlling various vehicle 20 controllers, e.g., a powertrain controller, a brake controller, a steering controller, etc. The computer 28 is generally arranged for communications on a vehicle 20 communication network that can include a bus in the vehicle 20 such as a controller area network (CAN) or the like, and/or other wired and/or wireless mechanisms.

As set forth above, each pixel 14 in the examples shown in FIGS. 6 and 8 include four SPADs. The memory of the computer 28 stores instructions executable by the processor to control the four SPADs to limit or eliminate dead time for each pixel 14. Specifically, the memory stores instructions to, for each of a plurality of the pixels 14, apply a bias voltage to the first SPAD 16 while no bias voltage or low bias voltage is applied to the second SPAD 18, remove the bias voltage from the first SPAD 16 of the pixel 14 and apply a bias voltage to the second SPAD 18 of the pixel 14 while no bias voltage or low bias voltage is applied to the first SPAD 16 of the pixel 14, and record detection of a photon by the first SPAD 16 of the pixel 14 and detection of a photon by the second SPAD 18 of the pixel 14 on a memory bank 34 of the pixel 14, i.e., a memory bank 34 that is common to all SPADs of the pixel 14. The bias control of each of the first SPAD 16 and the second SPAD 18 may also be performed automatically through hardwired circuitry to increase speed of the switching.

As described further below, in the example in FIG. 6, the first SPAD 16 and the third SPAD 36 are grouped to be biased at the same time and the second SPAD 18 and the fourth SPAD 38 are grouped to be biased at the same time. Alternatively, in the example shown in FIG. 8, the first SPAD 16, the second SPAD 18, the third SPAD 36, and the fourth SPAD 38 are biased at different times.

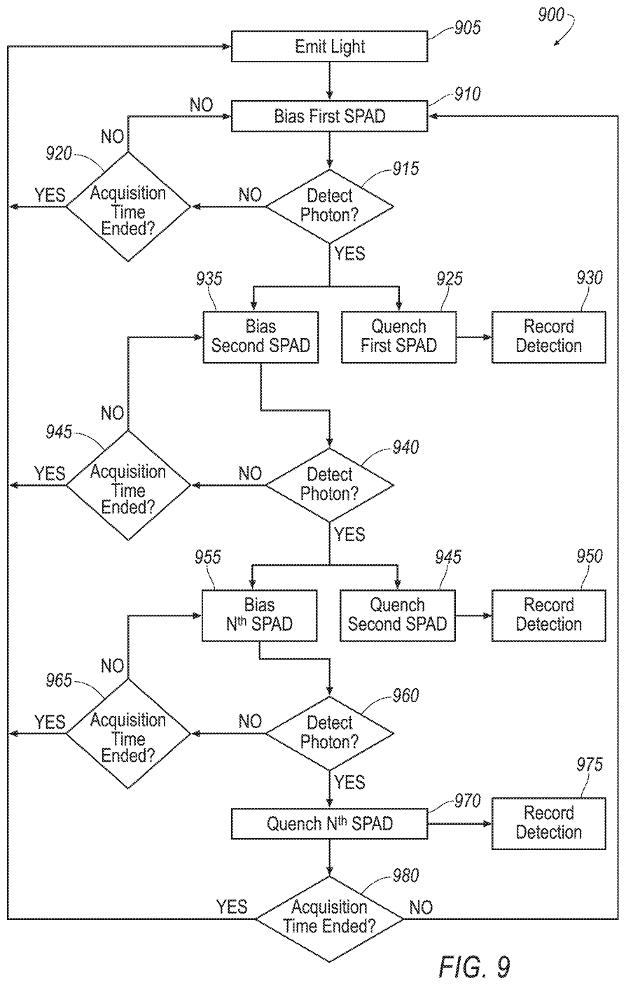

The method 900 is shown in FIG. 9. Method 900 is performed for each pixel 14 of the FPA 12. Specifically, the computer 28 performs method 900 for each pixel 14 of the FPA 12. Each of the pixels 14 may be operated according to the method 900 independently of operation of all other pixels 14 of the FPA 12.

With reference to block 905, the method includes emitting light from the light emitter 30. Specifically, the light emitter 30 emits one pulse of light at block 905. The computer 28 instructs the light emitter 30 to emit the light. For example, the computer 28 may pulse the light routinely based on a clock. The application of the bias voltage to the first SPAD 16 is clocked based on the emission of light from the light emitter 30. The computer 28 operates the SPADs as described below during an acquisition time. The acquisition time may be the time between pulses of light from the light emitter 30.

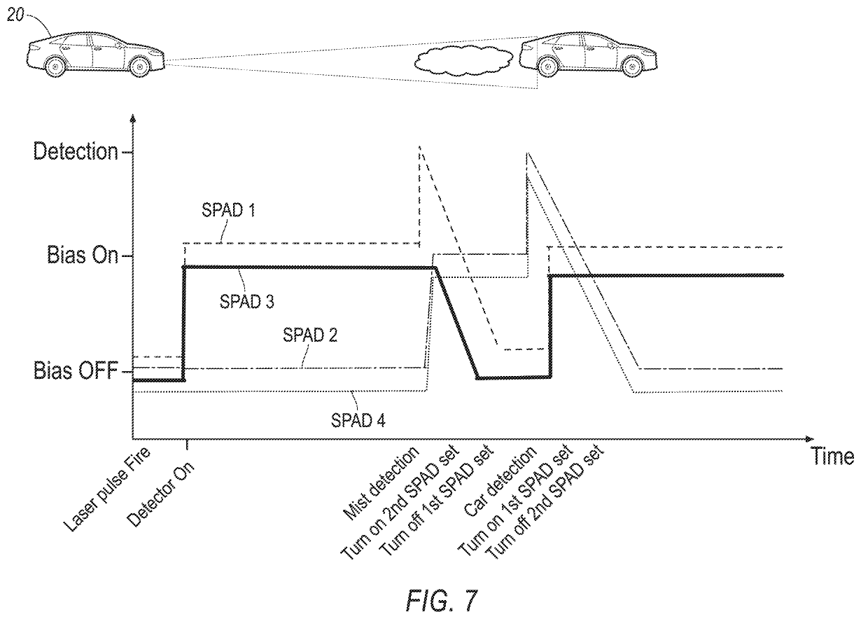

With reference to block 910, the method includes applying bias voltage to the first SPAD 16. In some examples, bias voltage is simultaneously applied to multiple SPADs of the pixel 14. For example, in the example shown in FIGS. 6 and 7, bias voltage is simultaneously applied to the first SPAD 16 and the third SPAD 36. In such examples, block 910 includes the simultaneous application of bias voltage to any SPADs that are grouped with the first SPAD 16, e.g., the third SPAD 36 in the example in FIGS. 6 and 7.

In decision block 915, the method includes determining whether a photon is detected by the first SPAD 16 during the application of the bias voltage to the first SPAD 16. If a photon is not detected, the method includes determining whether the acquisition time has ended in decision block 920. The bias voltage is applied to the first SPAD 16 until the acquisition time ends or a photon is detected by the first SPAD 16.

If the first SPAD 16 detects a photon at decision block 915, the method includes quenching the first SPAD 16 (block 925), recording the detection of the photon in the memory bank 34 of the pixel 14 (block 930), and applying bias voltage to the second SPAD 18 (block 935). The quenching of the first SPAD 16 in block 925 and the application of the bias voltage to the second SPAD 18 in block 935 may be simultaneous to reduce or eliminate dead time between the operation of the first SPAD 16 and the second SPAD 18. The quenching in block 925 and the recording of the detection of the photon in the memory bank 34 of the pixel 14 in block 930 may be performed during operation of the second SPAD 18, i.e., while bias voltage is applied to the second SPAD 18. The method includes removing the bias voltage from the first SPAD 16 after detecting the photon with the first SPAD 16. The bias voltage is removed from the first SPAD 16 when the first SPAD 16 detects the photon and, accordingly, the bias voltage is applied to the second SPAD 18 while no bias voltage or low bias voltage is applied to the first SPAD 16. The computer 28 may read from the memory bank 34 of the pixel 14 to perform operations of the Lidar system 10 described above. The memory bank 34 is common to all SPADs of the pixel 14; and the memory bank 34 may store data from more than one SPAD of the pixel 14 before being read out or the memory bank 34 may read out the data from one SPAD before the data from another SPAD is recorded in the memory bank 34.

In examples in which other SPADs of the pixel 14 are grouped with the first SPAD 16, e.g., the third SPAD 36 in FIGS. 6 and 7, decision block 915-930 includes determining whether a photon is detected by any SPAD grouped with the first SPAD 16, quenching the SPAD that detects a photon, and recording detection of the photon in the memory bank 34 of the pixel 14. In the example shown in FIGS. 6 and 7, the third SPAD 36 is grouped with the first SPAD 16 such that the first SPAD 16 and the third SPAD 36 are simultaneously biased at block 910. In block 915, the method includes determining whether a photon is detected by either one of the first SPAD 16 and the third SPAD 36. In the event one of the first SPAD 16 and the third SPAD 36 detects a photon at block 915, the SPAD that detected the photon is quenched (block 925) and the detection is recorded (block 930) and bias voltage is removed from both the first SPAD 16 and the third SPAD 36. As another example, the method 900 may include a coincidence requirement that both of the powered SPADS need to detect a photon in order to record an event. In such an example, detection by a single SPAD, and not the other SPAD, would still lead to the flipping to the other set of SPADs, but the rogue photon may not be recorded if the other SPAD did not also detect a photon.

With reference to block 935, the method includes applying bias voltage to the second SPAD 18 after detection of the photon by the first SPAD 16 (and/or detection by any other SPADs grouped with the first SPAD 16). In some examples, bias voltage is simultaneously applied to multiple SPADs of the pixel 14 at block 935. For example, in the example shown in FIGS. 6 and 7, bias voltage is simultaneously applied to the second SPAD 18 and the fourth SPAD 38. In such examples, block 935 includes the simultaneous application of bias voltage to any SPADs that are grouped with the second SPAD 18, e.g., the fourth SPAD 38 in the example in FIGS. 6 and 7.

In decision block 940, the method includes determining whether a photon is detected by the second SPAD 18 during the application of the bias voltage to the second SPAD 18. If a photon is not detected, the method includes determining whether the acquisition time has ended in decision block 945. Once the process at block 935 is initiated, the bias voltage is applied to the second SPAD 18 until the acquisition time ends or a photon is detected by the second SPAD 18.

If the second SPAD 18 detects a photon at decision block 940, the method includes quenching the second SPAD 18 (block 945), recording the detection of the photon in the memory bank 34 of the pixel 14 (block 950), and applying bias voltage to another second SPAD 18 (block 955). The quenching of the second SPAD 18 in block 945 and the application of the bias voltage to another SPAD in block 955 may be simultaneous to reduce or eliminate dead time between the operation of the second SPAD 18 and the next SPAD. The quenching in block 945 and the recording of the detection of the photon in the memory bank 34 of the pixel 14 in block 950 may be performed during operation of another SPAD (e.g., Nth SPAD in FIG. 9). The method includes removing the bias voltage from the second SPAD 18 after detecting the photon with the second SPAD 18. The bias voltage is removed from the second SPAD 18 when the second SPAD 18 detects the photon and, accordingly, the bias voltage is applied to another SPAD (e.g., the Nth SPAD) while no bias voltage or low bias voltage is applied to the second SPAD 18.

In examples in which other SPADs of the pixel 14 are grouped with the second SPAD 18, e.g., the fourth SPAD 38 in FIGS. 6 and 7, decision block 940-955 includes determining whether a photon is detected by any SPAD grouped with the second SPAD 18, quenching the SPAD that detects a photon, and recording detection of the photon in the memory bank 34 of the pixel 14. In the example shown in FIGS. 6 and 7, the fourth SPAD 38 is grouped with the second SPAD 18 such that the second SPAD 18 and the fourth SPAD 38 are simultaneously biased at block 935. In block 940, the method includes determining whether a photon is detected by either one of the second SPAD 18 and the fourth SPAD 38. In the event one of the second SPAD 18 and the fourth SPAD 38 detects a photon at block 940, the SPAD that detected the photon is quenched (block 945) and the detection is recorded (block 950) and bias voltage is removed from both the second SPAD 18 and the fourth SPAD 38. For example, FIG. 7 shows that the first SPAD 16 and the third SPAD 36 were biased until the first SPAD 16 detected a photon, at which point the first SPAD 16 and the third SPAD 36 were unbiased and the second SPAD 18 and the fourth SPAD 38 were biased. The second SPAD 18 and the fourth SPAD 38 were biased until both the second SPAD 18 and the fourth SPAD 38 detected photons, at which time the second SPAD 18 and the fourth SPAD 38 were unbiased and the first SPAD 16 and third SPAD 36 were biased. In the example shown in FIG. 7, the first SPAD 16 detected mist and the second SPAD 18 and fourth SPAD 38 detected a vehicle 20.

As shown in blocks 955-975, the process of biasing a SPAD, detecting a photon with the SPAD, quenching the SPAD, recording the detection, and then biasing another SPAD is repeated for all of the SPADs of the pixel 14 if photons are detected by each SPASD of the pixel 14 before the acquisition time ends. In the example shown in FIGS. 6 and 7, the pixel 14 includes two groups of SPADs, namely one group with the first SPAD 16 and the third SPAD 36 and another group with the second SPAD 18 and the fourth SPAD 38. In such an example, the method moves from block 945 to block 980 (i.e., blocks 955 goes back to 975 do not apply to the example shown in FIGS. 6 and 7). In the example shown in FIG. 8, the method goes from block 945 to blocks 955 through 975 for the third SPAD 36 and then the fourth SPAD 38.

The biasing a SPAD, detecting a photon with the SPAD, quenching the SPAD, recording the detection, and then biasing another SPAD is repeated until each of the SPADs of the pixel 14 has been biased or the acquisition time has ended. As shown in block 980, if each SPAD of the pixel 14 has detected a photon and the acquisition time has not ended, then the method repeats starting at block 910.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A method comprising:
emitting light from a light emitter;
applying a bias voltage to a first single-photon avalanche diode (SPAD) of a pixel;
detecting a photon with the first SPAD;
removing the bias voltage from the first SPAD after detecting the photon with the first SPAD;
applying a bias voltage to a second SPAD of the pixel after detecting the photon with the first SPAD and while no bias voltage or low bias voltage is applied to the first SPAD;
quenching the first SPAD during application of bias voltage to second SPAD.

2. The method as set forth in claim 1, further comprising recording the detection of the photon by the first SPAD in a memory bank of the pixel.

3. The method as set forth in claim 2, further comprising detecting a photon with the second SPAD and recording the detection of the photon by the second SPAD in the memory bank of the pixel.

4. The method as set forth in claim 3, further comprising:
removing the bias voltage from the second SPAD after detecting the photon with the second SPAD;
applying a bias voltage to the first SPAD after detecting the photon with the second SPAD and while no bias voltage or low bias voltage is applied to the second SPAD; and
quenching the second SPAD after detection of the photon with the second SPAD and during application of the bias voltage to the first SPAD.

5. The method as set forth in claim 2, wherein recording the detection of the photon by the first SPAD in the memory bank is during the application of bias voltage to the second SPAD.

6. The method as set forth in claim 1, further comprising:
removing the bias voltage from the second SPAD after detecting the photon with the second SPAD;
applying a bias voltage to the first SPAD after detecting the photon with the second SPAD and while no bias voltage or low bias voltage is applied to the second SPAD; and
quenching the second SPAD after detection of the photon with the second SPAD and during application of the bias voltage to the first SPAD.

7. The method as set forth in claim 1, further comprising:
applying a bias voltage to a third SPAD of the pixel simultaneously with the application of the bias voltage to the first SPAD;
removing the bias voltage from the third SPAD after detecting the photon with the first SPAD.

8. The method as set forth in claim 7, further comprising:
removing the bias voltage from the second SPAD after detecting the photon with the second SPAD;
simultaneously applying a bias voltage to the first SPAD and the third SPAD after detecting the photon with the second SPAD and while no bias voltage or low bias voltage is applied to the second SPAD; and
quenching the second SPAD after detection of the photon with the second SPAD and during application of the bias voltage to the first SPAD and the third SPAD.

9. The method as set forth in claim 7, further comprising:
applying a bias voltage to a fourth SPAD of the pixel simultaneously with the application of the bias voltage to the second SPAD;
removing the bias voltage from the second SPAD and the fourth SPAD after detecting the photon with the second SPAD.

10. The method as set forth in claim 9, further comprising:
simultaneously applying a bias voltage to the first SPAD and the third SPAD after detecting the photon with the second SPAD and while no bias voltage or low bias voltage is applied to the second SPAD and the third SPAD; and
quenching the second SPAD after detection of the photon with the second SPAD and during application of the bias voltage to the first SPAD and the third SPAD.

11. The method as set forth in claim 1, wherein removing the bias voltage from the first SPAD after detecting the photon with the first SPAD and applying the bias voltage to a second SPAD of the pixel after detecting the photon with the first SPAD is in response to the detection of the photon by the first SPAD.

12. The method as set forth in claim 1, wherein the application of the bias voltage to the first SPAD is clocked based on the emission of light from the light emitter.

13. The method as set forth in claim 1, wherein removing the bias voltage from the first SPAD and applying the bias voltage to the second SPAD is a periodic timing pattern.

14. A Lidar system comprising:
a focal-plane array having a plurality of pixels, each pixel including a first single-photon avalanche diode (SPAD) and a second SPAD; and
a computer having a processor and a memory storing instructions executable by the processor to:
for each of a plurality of the pixels, apply a bias voltage to the first SPAD while no bias voltage or low bias voltage is applied to the second SPAD;
remove the bias voltage from the first SPAD of the pixel and apply a bias voltage to the second SPAD of the pixel while no bias voltage or low bias voltage is applied to the first SPAD of the pixel; and
record detection of a photon by the first SPAD of the pixel and detection of a photon by the second SPAD of the pixel on a common memory bank of the pixel.

15. The Lidar system as set forth in claim 14, wherein the memory stores instructions to repeatedly alternate the bias voltage between the first SPAD and the second SPAD in response to detection of a photon by the one of the first SPAD and the second SPAD that receives bias voltage.

16. The Lidar system as set forth in claim 15, wherein the memory stores instructions to quench the first SPAD during application of bias voltage to the second SPAD and to quench the second SPAD during application of bias voltage to the first SPAD.

17. The Lidar system as set forth in claim 14, wherein the memory stores instructions to remove the bias voltage from the first SPAD and apply the bias voltage to the second SPAD while no bias voltage or low bias voltage is applied to the first SPAD in response to the detection of a photon by the first SPAD.

18. The Lidar system as set forth in claim 17, wherein the memory stores instructions to remove the bias voltage from the second SPAD and apply a bias voltage to the first SPAD while no bias voltage or low bias voltage is applied to the second SPAD in response to the detection of a photon by the second SPAD.

19. The Lidar system as set forth in claim 14, wherein the memory stores instructions to alternate the bias voltage between the first SPAD and the second SPAD in a periodic timing pattern.

20. The Lidar system as set forth in claim 14, wherein the memory stores instructions to quench the first SPAD during application of bias voltage to the second SPAD.

21. The Lidar system as set forth in claim 14, wherein the memory stores instructions to:
apply a bias voltage to a third SPAD of the pixel simultaneously with the application of the bias voltage to the first SPAD; and
remove the bias voltage from the third SPAD simultaneously with the removal of the bias voltage from the first SPAD.

22. The Lidar system as set forth in claim 21, wherein the memory stores instructions to:
apply a bias voltage to a fourth SPAD of the pixel simultaneously with the application of the bias voltage to the second SPAD;
remove the bias voltage from the fourth SPAD simultaneously with the removal of the bias voltage from the second SPAD.

23. A computer having a processor and a memory storing instructions executable by the processor to:
emit light from a light emitter;
apply a bias voltage to a first single-photon avalanche diode (SPAD) of a pixel while no bias voltage or low bias voltage is applied to a second SPAD of the pixel;
remove the bias voltage from the first SPAD and apply a bias voltage to the second SPAD of the pixel while no bias voltage or low bias voltage is applied to the first SPAD; and
record detection of a photon by the first SPAD and detection of a photon by the second SPAD on a common memory bank of the pixel.

24. The computer as set forth in claim 23, wherein the memory stores instructions to repeatedly alternate the bias voltage between the first SPAD and the second SPAD in response to detection of a photon by the one of the first SPAD and the second SPAD that receives bias voltage.

25. The computer as set forth in claim 24, wherein the memory stores instructions to quench the first SPAD during application of bias voltage to the second SPAD and to quench the second SPAD during application of bias voltage to the first SPAD.

26. The computer as set forth in claim 23, wherein the memory stores instructions to remove the bias voltage from the first SPAD and apply the bias voltage to the second SPAD while no bias voltage or low bias voltage is applied to the first SPAD in response to the detection of a photon by the first SPAD.

27. The computer as set forth in claim 26, wherein the memory stores instructions to remove the bias voltage from the second SPAD and apply a bias voltage to the first SPAD while no bias voltage or low bias voltage is applied to the second SPAD in response to the detection of a photon by the second SPAD.

28. The computer as set forth in claim 23, wherein the memory stores instructions to alternate the bias voltage between the first SPAD and the second SPAD in a periodic timing pattern.

29. The computer as set forth in claim 23, wherein the memory stores instructions to quench the first SPAD during application of bias voltage to the second SPAD.

30. The computer as set forth in claim 23, wherein the memory stores instructions to:
apply a bias voltage to a third SPAD of the pixel simultaneously with the application of the bias voltage to the first SPAD; and
remove the bias voltage from the third SPAD simultaneously with the removal of the bias voltage from the first SPAD.

31. The computer as set forth in claim 30, wherein the memory stores instructions to:
apply a bias voltage to a fourth SPAD of the pixel simultaneously with the application of the bias voltage to the second SPAD;
remove the bias voltage from the fourth SPAD simultaneously with the removal of the bias voltage from the second SPAD.
